(19) United States
(12) Patent Application Publication
(10) Pub. No.: US 2015/0062541 A1
(43) Pub. Date: Mar. 5, 2015

(54) LIGHT EMITTING DEVICE AND PROJECTOR

(71) Applicant: Seiko Epson Corporation, Tokyo (JP)

(72) Inventor: Masamitsu MOCHIZUKI, Fujimi (JP)

(21) Appl. No.: 14/469,940

(22) Filed: Aug. 27, 2014

(30) Foreign Application Priority Data
Aug. 30, 2013 (JP) 2013-179094

(51) Int. Cl. G03B 21/14; F21V 8/00; G02B 6/42; G02B 6/036

(52) U.S. Cl. CPC G03B 21/142; G02B 6/036; G02B 6/0096; G02B 6/4298
USPC 353/38; 362/555

(57) ABSTRACT

A light emitting device includes: an active layer; and a first lens, a second lens, a third lens, and a fourth lens on which light generated by the active layer becomes incident. The active layer forms a first optical waveguide and a second optical waveguide. The first optical waveguide has a first bouncing section and a second bouncing section. The second optical waveguide has a third bouncing section and a fourth bouncing section. The first lens is provided at a position overlapping with the first bouncing section. The second lens is provided at a position overlapping with the second bouncing section and the second optical waveguide. The third lens is provided at a position overlapping with the third bouncing section and the first optical waveguide. The fourth lens is provided at a position overlapping with the fourth bouncing section.

### BACKGROUND

1. Technical Field

The present invention relates to a light emitting device and a projector.

2. Related Art

A super luminescent diode (hereinafter also referred to as “SLD”) is a semiconductor light emitting element which achieves incoherence like an ordinary light emitting diode and also achieves a broad-range spectral shape while having a light output characteristic such that an output up to several hundred mW can be provided by a single element, as in a semiconductor laser. Such an SLD is used, for example, as a light source of a projector.

For example, JP-A-2010-141241 discloses an SLD in which light emitted from two light emitting sections is reflected in a stacking direction (stacking direction of an active layer and a cladding layer) by an inclined surface provided on a lateral side of a light emitting device.

However, in the case where the SLD of JP-A-2010-141241 is used as the light source of a projector, when the gain region (optical waveguide) is elongated in order to increase light output, the distance between lenses corresponding to the two light emitting sections increases. On the other hand, when the distance between the lenses corresponding to the two light emitting sections is decreased, the optical waveguide is shortened, reducing light output. In this way, in the SLD of JP-A-2010-141241, it is difficult to decrease the distance between the lenses without reducing the length of the optical waveguide.

### SUMMARY

An advantage of some aspects of the invention is that a light emitting device is provided in which the distance between lenses can be decreased without reducing the length of the optical waveguide. Another advantage of some aspects of the invention is that a projector including the light emitting device is provided.

An aspect of the invention is directed to a light emitting device including: an active layer which is injected with current and generates light; a first cladding layer and a second cladding layer which sandwich the active layer; and a first lens, a second lens, a third lens, and a fourth lens on which the light generated by the active layer becomes incident. The active layer forms a first optical waveguide and a second optical waveguide which guide light. The first optical waveguide has a first bouncing section and a second bouncing section which change a traveling direction of the light guided by the first optical waveguide. The second optical waveguide has a third bouncing section and a fourth bouncing section which change a traveling direction of the light guided by the second optical waveguide. The first lens is provided at a position overlapping with the first bouncing section, as viewed from a stacking direction of the active layer and the first cladding layer. The second lens is provided at a position overlapping with the second bouncing section and the second optical waveguide, as viewed from the stacking direction. The third lens is provided at a position overlapping with the third bouncing section and the first optical waveguide, as viewed from the stacking direction. The fourth lens is provided at a position overlapping with the fourth bouncing section, as viewed from the stacking direction.

In such a light emitting device, three lenses can be arranged in an overlapping manner on one optical waveguide in plan view. Specifically, the first optical waveguide overlaps with the first lens, the second lens and the third lens. The second optical waveguide overlaps with the second lens, the third lens and the fourth lens. Therefore, in such a light emitting device, the distance between the first lens, the second lens, the third lens and the fourth lens can be decreased without reducing the length of the first optical waveguide and the second optical waveguide, compared with the case where lenses overlap only with both ends of the optical waveguide.

In the light emitting device according to the aspect of the invention, the first bouncing section, the second bouncing section, the third bouncing section and the fourth bouncing section may change the traveling direction of light by diffraction.

In such a light emitting device, manufacturing cost can be reduced, for example, compared with the case where the traveling direction of light is changed by using a prism. Moreover, in such a light emitting device, the distance between the first optical waveguide and the second optical waveguide can be decreased, thus achieving miniaturization, compared with the case where the traveling direction of light is changed by using a prism.

In the light emitting device according to the aspect of the invention, the first optical waveguide may have a fifth bouncing section provided at a position overlapping with the third lens, as viewed from the stacking direction.

In such a light emitting device, the number of light emitting sections (sections that emit light) of a light emitting element including the active layer, the first cladding layer and the second cladding layer can be increased.

In the light emitting device according to the aspect of the invention, the second optical waveguide may have a sixth bouncing section provided at a position overlapping with the second lens, as viewed from the stacking direction.

In such a light emitting device, the number of light emitting sections of a light emitting element including the active layer, the first cladding layer and the second cladding layer can be increased.

In the light emitting device according to the aspect of the invention, the first optical waveguide may have a seventh bouncing section provided at a position overlapping with the fourth lens, as viewed from the stacking direction.

In such a light emitting device, the length of the first optical waveguide can be increased. Therefore, in such a light emitting device, light output can be increased.

In the light emitting device according to the aspect of the invention, the second optical waveguide may have an eighth bouncing section provided at a position overlapping with the first lens, as viewed from the stacking direction.

In such a light emitting device, the length of the second optical waveguide can be increased. Therefore, in such a light emitting device, light output can be increased.

In the light emitting device according to the aspect of the invention, the first optical waveguide and the second optical waveguide may be integrally formed.

In such a light emitting device, the distance between the first lens, the second lens, the third lens and the fourth lens can be decreased without reducing the length of the first optical waveguide and the second optical waveguide.

Another aspect of the invention is directed to a projector including: the light emitting device according to the aspect of the invention; a light modulation device which modulates light emitted from the light emitting device, according to image information; and a projection device which projects an image formed by the light modulation device.

Such a projector can include the light emitting device in which the length of the first optical waveguide and the second optical waveguide can be increased and the distance between the first lens, the second lens, the third lens and the fourth lens can be decreased.

### BRIEF DESCRIPTION OF THE DRAWINGS

The invention will be described with reference to the accompanying drawings, wherein like numbers reference like elements.

FIG. 1 is a plan view schematically showing a light emitting device according to a first embodiment.

FIG. 2 is a plan view schematically showing the light emitting device according to the first embodiment.

FIG. 3 is a cross-sectional view schematically showing the light emitting device according to the first embodiment.

FIG. 4 is a cross-sectional view schematically showing the light emitting device according to the first embodiment.

FIG. 5 is a perspective view schematically showing the light emitting device according to the first embodiment.

FIG. 6 is a perspective view schematically showing the light emitting device according to the first embodiment.

FIG. 7 is a cross-sectional view schematically showing a manufacturing process of the light emitting device according to the first embodiment.

FIG. 8 is a cross-sectional view schematically showing the manufacturing process of the light emitting device according to the first embodiment.

FIG. 9 is a cross-sectional view schematically showing the manufacturing process of the light emitting device according to the first embodiment.

FIG. 10 is a plan view schematically showing a light emitting device according a first modification of the first embodiment.

FIG. 11 is a plan view schematically showing a light emitting device according a second modification of the first embodiment.

FIG. 12 is a plan view schematically showing a light emitting device according a third modification of the first embodiment.

FIG. 13 is a plan view schematically showing a light emitting device according to a second embodiment.

FIG. 14 is a plan view schematically showing the light emitting device according to the second embodiment.

FIG. 15 is a plan view schematically showing a light emitting device according to a modification of the second embodiment.

FIG. 16 schematically shows a projector according to a third embodiment.

### DESCRIPTION OF EXEMPLARY EMBODIMENTS

Hereinafter, preferred embodiments of the invention will be described in detail with reference to the drawings. The following embodiments should not unduly limit the contents of the invention described in the appended claims. Not all the configurations described below are essential components of the invention.

### 1. First Embodiment

### 1.1. Light Emitting Device

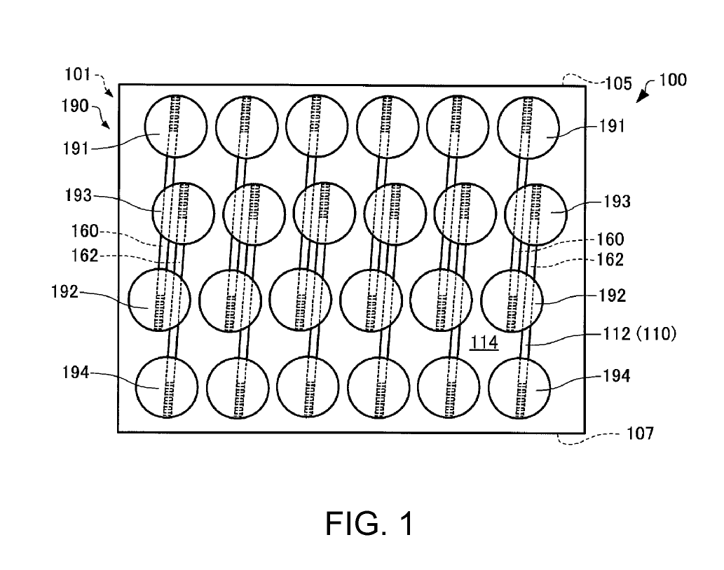

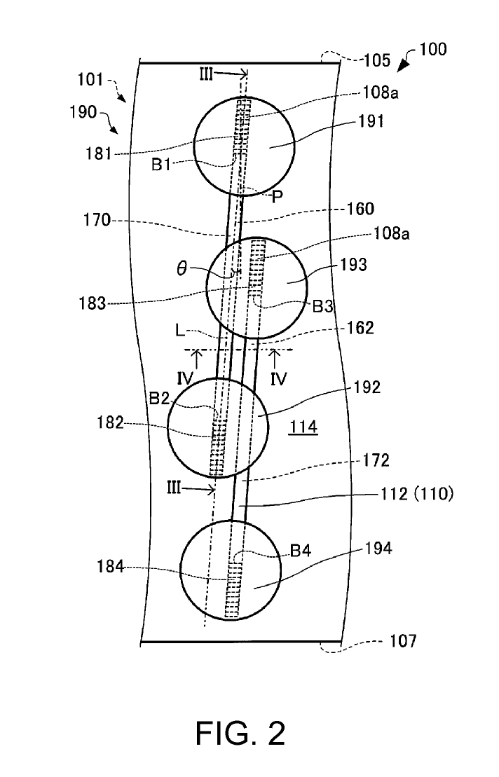

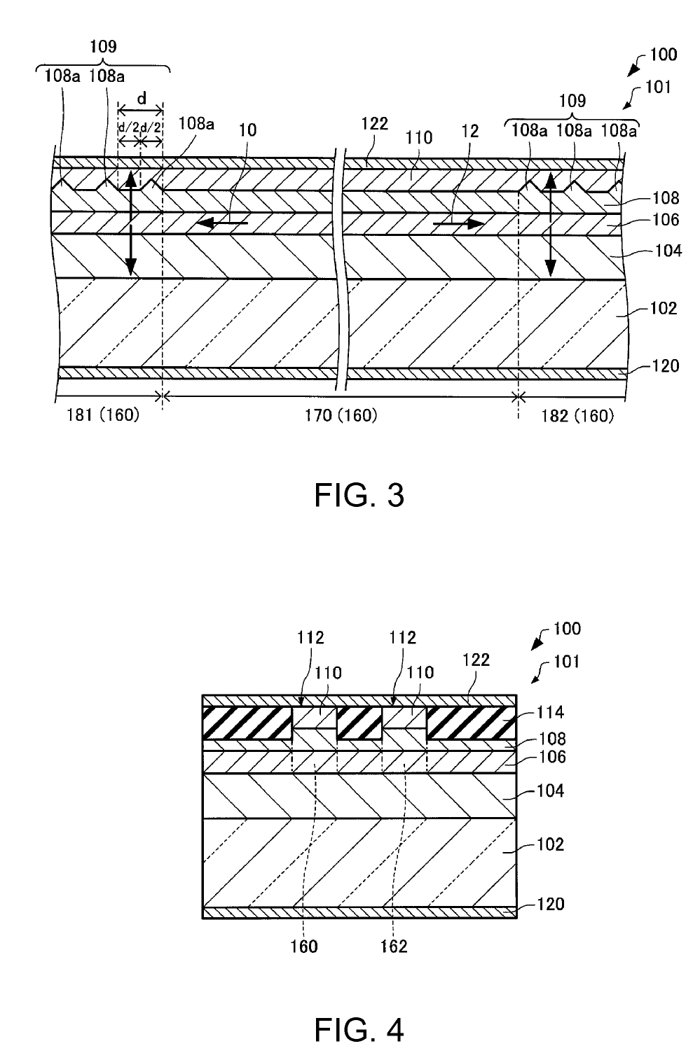

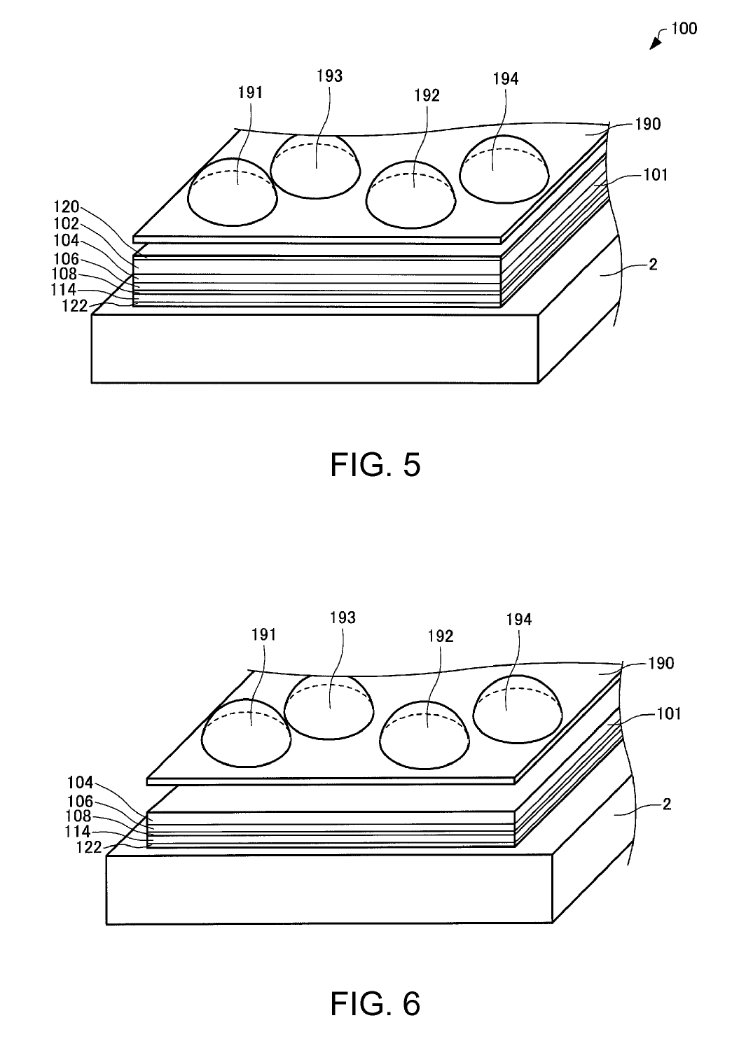

First, a light emitting device according to a first embodiment will be described with reference to the drawings. FIGS. 1 and 2 are plan views schematically showing a light emitting device 100 according to the first embodiment. FIG. 3 is a cross-sectional view taken along III-III in FIG. 2, schematically showing the light emitting device 100 according to the first embodiment. FIG. 4 is a cross-sectional view taken along IV-IV in FIG. 2, schematically showing the light emitting device 100 according to the first embodiment. FIG. 5 is a perspective view schematically showing the light emitting device 100 according to the first embodiment.

For convenience, in FIGS. 1 and 2, a second electrode 122 is omitted and a part of a lens array 190 is transparently shown. FIG. 2 is an enlarged view of a part of the light emitting device 100 shown in FIG. 1. In FIGS. 3 and 4, a wiring substrate 2 and the lens array 190 are omitted from the illustrations.

The light emitting device 100 includes a light emitting element 101, a lens array 190, and a wiring substrate 2, as shown in FIG. 5. The light emitting element 101 includes a substrate 102, a first cladding layer 104, an active layer 106, a second cladding layer 108, a contact layer 110, an insulation layer 114, a first electrode 120, and a second electrode 122, as shown in FIGS. 3 to 5.

Hereinafter, the case where the light emitting element 101 is an InGaAlP-based (red-colored) SLD will be described. In the SLD, unlike a semiconductor laser, laser oscillation can be prevented by suppressing the formation of a resonator formed by edge reflections. Therefore, speckle noise can be reduced.

The substrate 102 is, for example, a GaAs substrate of a first conduction type (for example, n-type). The substrate 102 may be capable of transmitting light generated by the active layer 106 (by optical waveguides 160, 162).

The first cladding layer 104 is formed on the substrate 102. The first cladding layer 104 is, for example, an n-type InGaAlP layer. Although not shown, a buffer layer may be formed between the substrate 102 and the first cladding layer 104. The buffer layer is, for example, an n-type GaAs layer, AlGaAs layer, InGaP layer or the like. The buffer layer can improve the crystal quality of the layers formed above the buffer layer.

The active layer 106 is formed on the first cladding layer 104. The active layer 106 has, for example, a multiple quantum well (MQW) structure in which three quantum well structures are superimposed, each including an InGaP well layer and an InGaAlP barrier layer.

The active layer 106 has, for example, a rectangular shape as viewed from the stacking direction of the active layer 106 and the first cladding layer 104 (hereinafter also referred to as “as viewed in a plan view”). The active layer 106 has a first lateral surface 105 and a second lateral surface 107, as shown in FIGS. 1 and 2. The lateral surfaces 105, 107 are opposite each other (parallel surfaces) and are not in surface contact with the cladding layers 104, 108. The lateral surfaces 105, 107 are, for example, cleavage planes formed by cleavage.

Apart of the active layer 106 forms a first optical waveguide 160 and a second optical waveguide 162 which guide light. In the active layer 106, the optical waveguides 160, 162 can generate light by injection current. The light guided by the optical waveguides 160, 162 can receive gain at the portion where current is injected.

The first optical waveguide 160 has, for example, a strip-like and straight longitudinal shape, as viewed in a plan view. In the illustrated example, the first optical waveguide 160 is in the shape of a parallelogram, as viewed in a plan view. The length of the first optical waveguide 160 (size in the longitudinal direction) is, for example, approximately 3 mm. The first optical waveguide 160 has a first waveguide section 170, a first bouncing section 181, and a second bouncing section 182, as shown in FIGS. 2 and 3.

As viewed in a plan view, the first waveguide section 170 is a portion that does not overlap with a grating section 109, described later, which is provided on the second cladding layer 108 of the first optical waveguide 160. The first waveguide section 170 extends from the first bouncing section 181 to the second bouncing section 182. That is, one end of the first waveguide section 170 is connected to the first bouncing section 181, while the other end of the first waveguide section 170 is connected to the second bouncing section 182. It can also be said that the first waveguide section 170 connects the first bouncing section 181 and the second bouncing section 182. The first waveguide section 170 is provided at a position overlapping with a third lens 193 of the lens array 190, as viewed in a plan view. The first waveguide section 170 has a strip-like and straight longitudinal shape with a predetermined width and along an extending direction of the first waveguide section 170, as viewed in a plan view.

The “extending direction of the first waveguide section 170” is, for example, the extending direction of an imaginary straight line L passing through the center of the one end of the first waveguide section 170 and the center of the other end. Also, the “extending direction of the first waveguide section 170” may be the extending direction of the boundary of the first waveguide section 170 (and the area excluding the first waveguide section 170). This also applies to a second waveguide section 172 of the second optical waveguide 162.

The first waveguide section 170 is in the shape of a parallelogram, as viewed in a plan view. In the example shown in FIG. 2, the bouncing sections 181, 182 are also in the shape of a parallelogram, as viewed in a plan view. The first waveguide section 170 is inclined with respect to an imaginary straight line P orthogonal to a first boundary B1 with the first bouncing section 181. An inclination angle θ of (the imaginary straight line L of) the first waveguide section 170 with respect to the imaginary straight line P is, for example, 0.5° or greater and 1.5° or smaller, though the angle varies depending on the length of the first waveguide section 170. Similarly, the first waveguide section 170 is inclined with respect to an imaginary straight line (not shown) orthogonal to a second boundary B2 with the second bouncing section 182. Thus, direct multiple reflection between the first bouncing section 181 and the second bouncing section 182, of the light generated in the first waveguide section 170, can be suppressed. Therefore, formation of a direct resonator can be avoided and laser oscillation of the light generated in the first optical waveguide 160 can be suppressed. Moreover, since the small inclination angle θ of 1.5° or smaller is applied, distortion of the radiation pattern of the light emitted from the light emitting element 101 can be reduced.

The boundaries B1, B2 are the boundaries between the first waveguide section 170 and the bouncing sections 181, 182, as viewed in a plan view. In the example shown in FIG. 2, the boundaries B1, B2 are parallel to the lateral surfaces 105, 107 of the active layer 106.

The inclination angle θ of the first waveguide section 170 with respect to the imaginary straight line P may be 0°. That is, the first waveguide section 170 may be provided orthogonally to the boundaries B1, B2. For example, by reducing the number of protrusions 108a, described later, provided on the second cladding layer 108, laser oscillation of the light generated in the first optical waveguide 160 can be suppressed even in the case of θ=0°.

The first waveguide section 170 generates light with the current that is injected by the electrodes 120, 122. The light generated in the first waveguide section 170 is guided by the first waveguide section 170 while receiving gain.

As viewed in a plan view, the bouncing sections 181, 182 are portions overlapping with the grating section 109, described later, provided on the second cladding layer 108 of the first optical waveguide 160. The first bouncing section 181 is provided at the one end of the first waveguide section 170, and in the illustrated example, on the side of the first lateral surface 105. The second bouncing section 182 is provided at the other end of the first waveguide section 170, and in the illustrated example, on the side of the second lateral surface 107.

The bouncing sections 181, 182 function as a diffraction grating by the grating section 109. The bouncing sections 181, 182 changes the traveling direction of the light guided by the first waveguide section 170 and causes the light to become incident on lenses 191, 192 of the lens array 190. That is, the bouncing sections 181, 182 change the traveling direction of light by diffraction. Specifically, the bouncing sections 181, 182 change the traveling direction of the light (bounce the light) that travels through the first waveguide section 170 in a direction (hereinafter referred to as “planar direction”) orthogonal to the stacking direction of the active layer 106 and the first cladding layer 104, and cause the light to become incident on the lenses 191, 192 of the lens array 190. The bouncing sections 181, 182 are, for example, DBRs (distributed Bragg reflectors).

The light bounced by the bouncing sections 181, 182 travels in a direction that is not parallel to the stacking direction of the active layer 106 and the first cladding layer 104, when the inclination angle is not θ=0°. Specifically, when the inclination angle θ is 1° or smaller, the traveling direction of the light bounced by the bouncing sections 181, 182 is inclined at angle of 5° or smaller with respect to the stacking direction of the active layer 106 and the first cladding layer 104.

The order of the bouncing sections 181, 182 (order of the diffraction grating) n is, for example, an even number, though it is not particularly limited as long as the bouncing section 181, 182 can cause the light guided by the first waveguide section 170 to become incident on the lenses 191, 192 of the lens array 190. The diffraction grating of the n-th order generates diffracted light of the m-th order (0≦m≦n, m being an integer). When n is an even number, the bouncing sections 181, 182 can cause diffracted light of the m=(n/2)-th order to become incident on the lenses 191, 192. Preferably, n=2 may be employed. As n increases above 2, diffracted light of a higher order is generated by the bouncing sections 181, 182. That is, diffracted light that travels in a greater number of directions is generated and this is not preferable in view of light efficiency.

The m-th order of the diffracted light is expressed by the following equation (1), where d represents the period of the grating in the grating section 109, λ represents the wavelength in the first waveguide section 170 of the light generated in the first waveguide section 170, α represents the incident angle of the light that becomes incident on the bouncing sections 181, 182 from the first waveguide section 170, and β represents the exit angle of the light exiting the bouncing sections 181, 182.

d sin α+d sin β=mλ (1)

In a diffraction grating of the second order (n=2), that is, when d=λ is applied to the equation (1), a component of the light traveling through the first waveguide section 170 in a direction orthogonal to the stacking direction of the active layer 106 and the first cladding layer 104) (α=90°) can become a diffracted light of the first order (m=1), a component of the diffracted light traveling in the stacking direction) (β=0°).

The bouncing sections 181, 182 are situated between the electrodes 120, 122, as shown in FIG. 3, and injected with a current by the electrodes 120, 122. The bouncing sections 181, 182 can generate light with the injection current. The light guided by the bouncing sections 181, 182 can receive gain.

Although not shown, the bouncing sections 181, 182 may not overlap with the electrodes 120, 122 as viewed in a plan view and may not be injected with a current, as long as the bouncing sections 181, 182 can guide light. The light guided by the bouncing sections 181, 182 may not receive gain.

The second optical waveguide 162 is provided at a position overlapping with the second lens 192 of the lens array 190, as viewed in a plan view, as shown in FIG. 2. The second optical waveguide 162 is spaced apart from the first optical waveguide 160. The distance between the optical waveguides 160, 162 is not particularly limited, as long as the second lens 192 overlaps with the second optical waveguide 162 and the third lens 193 overlaps with the first optical waveguide 160, as viewed in a plan view.

The second optical waveguide 162 is situated at a position shifted toward the second lateral surface 107 from the first optical waveguide 160, as viewed in a plan view. Moreover, the second optical waveguide 162 is situated at a position shifted along the in-plane direction of the first lateral surface 105 or the second lateral surface 107 from the first optical waveguide 160, as viewed in a plan view.

The second optical waveguide 162 may be provided in parallel with the first optical waveguide 160, as viewed in a plan view. The second optical waveguide 162 may have the same shape and function as the first optical waveguide 160. Hereinafter, the portions of the second optical waveguide 162 to which the description of the first optical waveguide 160 can be applied will not be described further in detail.

The second optical waveguide 162 has the second waveguide section 172, a third bouncing section 183, and a fourth bouncing section 184.

As viewed in a plan view, the second waveguide section 172 is a portion that does not overlap with the grating section 109 provided on the second cladding layer 108 of the second optical waveguide 162. The second waveguide section 172 extends from the third bouncing section 183 to the fourth bouncing section 184. The second waveguide section 172 is inclined with respect to an imaginary straight line (not shown) orthogonal to a third boundary B3 with the third bouncing section 183. Similarly, the second waveguide section 172 is inclined with respect to an imaginary straight line (not shown) orthogonal to a fourth boundary B4 with the fourth bouncing section 184. Thus, direct multiple reflection between the third bouncing section 183 and the fourth bouncing section 184, of the light generated in the second waveguide section 172, can be suppressed. Therefore, formation of a direct resonator can be avoided and laser oscillation of the light generated in the second optical waveguide 162 can be suppressed.

As viewed in a plan view, the bouncing sections 183, 184 are portions overlapping with the grating section 109 provided on the second cladding layer 108 of the second optical waveguide 162. The third bouncing section 183 is provided at the end of the second waveguide section 172, and in the illustrated example, on the side of the first lateral surface 105. The fourth bouncing section 184 is provided at the other end of the second waveguide section 172, and in the illustrated example, on the side of the second lateral surface 107. The bouncing sections 183, 184 function as a diffraction grating by the grating section 109. The bouncing sections 183, 184 change the traveling direction of the light guided by the second waveguide section 172 and cause the light to become incident on the lenses 193, 194 of the lens array 190. That is, the bouncing sections 183, 184 change the traveling direction of light by diffraction.

The optical waveguides 160, 162 are provided in a plural number, as shown in FIG. 1. In the illustrated example, optical waveguides 160, 162 are alternately arrayed in a direction orthogonal to the direction from the first lateral surface 105 to the second lateral surface 107 (in other words, a direction parallel to the in-plane direction of the first lateral surface 105 or the second lateral surface 107).

The second cladding layer 108 is formed on the active layer 106, as shown in FIGS. 3 and 4. The second cladding layer 108 is, for example, an InGaAlP layer of a second conduction type (for example, p-type). The cladding layers 104, 108 are layers with a greater band gap and a lower refractive index than the active layer 106. The cladding layers 104, 108 have the function of preventing leakage of injected carriers (electrons and positive holes) and light from both sides of the active layer 106.

The second cladding layer 108 has plural protrusions 108a on an upper surface thereof (surface contacting the contact layer 110), as shown in FIG. 3. The number of the protrusions 108a is not particularly limited. The protrusions 108a may have a parallelogrammatic planar shape and a triangular cross-sectional shape, as shown in FIGS. 2 and 3.

The protrusions 108a on the second cladding layer 108 are arrayed along the extending direction of the waveguide sections 170, 172 of the optical waveguides 160, 162. The protrusions 108a are arranged with the period d=λ=λ₀/n_{eff} along the extending direction of the waveguide sections 170, 172 (traveling direction of the light guided by the waveguide sections 170, 172) and form the grating section 109, as shown in FIG. 3. Specifically, each of the protrusions 108a has a size of d/2 (that is, λ₀/(2n_{eff})) in the extending direction of the waveguide sections 170, 172, and the width between the neighboring protrusions 108a is d/2 (that is, λ₀/(2n_{eff})). Here, λ₀ represents the wavelength in a vacuum or atmosphere, of the light generated in the optical waveguides 160, 162, and n_{eff} represents the effective refractive index in a vertical cross section (stacking direction) of the portion where the protrusions 108a are provided.

With the grating section 109 provided on the second cladding layer 108, the bouncing sections 181, 182, 183, 184 can function as diffraction gratings and change the traveling direction of the light guided by the waveguide sections 170, 172.

The shape of the grating section 109 is not particularly limited as long as the grating section 109 can enable the bouncing sections 181, 182, 183, 184 to function as diffraction gratings. For example, the grating section 109 may have a recess-protrusion shape having a rectangular recess and protrusion, as viewed in a plan view. Also, the grating section 109 may be provided at the boundary between the first cladding layer 104 and the active layer 106 or the boundary between the second cladding layer 108 and the active layer 106.

In the light emitting element 101, the p-type second cladding layer 108, the active layer 106 that is not doped with impurities, and the n-type first cladding layer 104 form a pin diode. In the light emitting element 101, as a forward bias voltage of the pin diode is applied (a current is injected) between the electrodes 120, 122, optical waveguides 160, 162 are generated in the active layer 106 and recombination of electrons and positive holes occurs in the optical waveguides 160, 162. This recombination generates light. Starting with the generated light, stimulated emission occurs and the intensity of the light is amplified within the optical waveguides 160, 162. The optical waveguides 160, 162 are formed by the active layer 106, which guides light, and the cladding layers 104, 108, which prevent leakage of light.

For example, as shown in FIG. 3, light 10 generated in the first waveguide section 170 of the first optical waveguide 160 and propagating toward the first bouncing section 181 is amplified by the first waveguide section 170 and subsequently changes the traveling direction thereof at the first bouncing section 181. Specifically, the light 10 changes the traveling direction thereof at the first bouncing section 181 and advances toward the second electrode 122 and toward the first electrode 120. The light 10 may be amplified at the first bouncing section 181. Similarly, light 12 generated in the first waveguide section 170 and propagating toward the second bouncing section 182 is amplified by the first waveguide section 170 and subsequently changes the traveling direction thereof at the second bouncing section 182. The light 12 may be amplified at the second bouncing section 182.

Meanwhile, light generated in the second waveguide section 172 of the second optical waveguide 162 and propagating toward the third bouncing section 183 is amplified by the second waveguide section 172 and subsequently changes the traveling direction thereof at the third bouncing section 183. This light may be amplified at the third bouncing section 183. Similarly, light generated in the second waveguide section 172 and propagating toward the fourth bouncing section 184 is amplified by the second waveguide section 172 and subsequently changes the traveling direction thereof at the fourth bouncing section 184. This light may also be amplified at the fourth bouncing section 184.

The contact layer 110 is formed on the second cladding layer 108, as shown in FIG. 4. The contact layer 110 is in ohmic contact with the second electrode 122. In the illustrated example, the planar shape of the upper surface (a contact surface with the second electrode 122) of the contact layer 110 is the same as the planar shape of the optical waveguides 160, 162. The contact layer 110 is, for example, a p-type GaAs layer.

The contact layer 110 and a part of the second cladding layer 108 form a pillar-shaped section 112. The planar shape of the pillar-shaped section 112 is, for example, the same as the planar shape of the optical waveguides 160, 162. The planar shape of the pillar-shaped section 112 determines the current route between the electrodes 120, 122, and consequently determines the planar shape of the optical waveguides 160, 162. Although not shown, a lateral surface of the pillar-shaped section 112 may be inclined.

The insulation layer 114 is formed on the second cladding layer 108 and the lateral side of the pillar-shaped section 112 (around the pillar-shaped section 112, as viewed in a plan view). The insulation layer 114 is in contact with the lateral surfaces of the pillar-shaped section 112. The upper surface of the insulation layer 114 may continue to the upper surface of the contact layer 110, as shown in FIG. 4. The insulation layer 114 is, for example, a SiN layer, SiO2 layer, SiON layer, Al2O3 layer, or polyimide layer. When these materials are used as the insulation layer 114, the current between the electrodes 120, 122 avoids the insulation layer 114 and flows to the pillar-shaped section 112 held between the insulation layers 114.

The insulation layer 114 has a lower refraction index than the refractive index of the second cladding layer 108. The effective refractive index of the vertical cross section in the portion where the insulation layer 114 is formed is lower than the effective refractive index of the vertical cross section of the portion where the insulation layer 114 is not formed, that is, the portion where the pillar-shaped section 112 is formed. Thus, in the planar direction, the light can be efficiently confined within the optical waveguides 160, 162. Although not shown, the insulation layer 114 may not be provided. In this case, an air surrounding the pillar-shaped section 112 realizes the similar function to the insulation layer 114.

The first electrode 120 is formed on the entire surface under the substrate 102. Specifically, the first electrode 120 is formed in contact with the lower surface of the layer (in the illustrated example, the substrate 102) that is in ohmic contact with the first electrode 120. The first electrode 120 is electrically connected to the first cladding layer 104 via the substrate 102. The first electrode 120 is one electrode for driving the light emitting device 100. As the first electrode 120, for example, a Cr layer, an AuGe layer, Ni layer and an Au layer are stacked in this order from the side of the substrate 102. The first electrode 120 may be composed of other materials capable of transmitting the light generated in the active layer 106.

It is also possible to provide a second contact layer (not shown) between the first cladding layer 104 and the substrate 102, then expose the surface of this second contact layer opposite to the substrate 102 by dry etching from the side opposite to the substrate 102 or the like, and provide the first electrode 120 on the second contact layer. This can provide a single-sided electrode structure. This configuration is particularly effective in the case where the substrate 102 is insulative.

The second electrode 122 is formed on the contact layer 110. Specifically, the second electrode 122 is formed in contact with the upper surface of the contact layer 110. The second electrode 122 may also be formed on the insulation layer 114, as shown in FIG. 4. The second electrode 122 is electrically connected to the second cladding layer 108 via the contact layer 110. The second electrode 122 is the other electrode for driving the light emitting device 100. As the second electrode 122, for example, a Cr layer, an AuZn layer and an Au layer are stacked in this order from the side of the contact layer 110. The second electrode 122 may be composed of other materials capable of transmitting the light generated in the active layer 106.

The wiring substrate 2 supports the light emitting element 101, as shown in FIG. 5. In the example shown in FIG. 5, the light emitting element 101 mounted on the wiring substrate 2, with the side of the second electrode 122 facing the wiring substrate 2 (so-called junction-down mounting). The wiring substrate 2 is formed, for example, by a silicon substrate with wires to be electrically connected to the electrode 120, 122. Although not shown, the light emitting element 101 may be mounted on the wiring substrate 2, with the side of the first electrode 120 facing the wiring substrate (so-called junction-up mounting). Also, the electrical connection between the wires and the first electrode 120 or the second electrode 122 can be realized by direct contact or via an electrically conductive material such as a solder, sliver paste or gold wire.

As shown in FIG. 5, in the light emitting element 101 that is mounted by a junction-down mounting, the light traveling toward the first electrode 120 via the bouncing sections 181, 182, 183, 184 is transmitted through the substrate 102 and the first electrode 120 and becomes incident on the lens array 190. The light traveling toward the second electrode 122 via the bouncing sections 181, 182, 183, 184 may be reflected by the second electrode 122 and reach the lens array 190.

When the substrate 102 and the first electrode 120 are not transparent to the light generated in the optical waveguides 160, 162, the substrate 102 may be eliminated, as shown in FIG. 6. When the substrate 102 is a GaAs substrate, for example, the substrate 102 can be eliminated by diluted hydrochloric acid or the like. Although not shown, the first electrode 120 may be formed on a surface of the first cladding layer 104 that does not overlap with the optical waveguides 160, 162, as viewed in a plan view, or may be formed as the above-described single-sided electrode structure.

The light emitted from the light emitting element 101 becomes incident on the lens array 190. The lens array 190 is arranged in the stacking direction of the active layer 106 and the first cladding layer 104 with respect to the light emitting element 101. In the example shown in FIG. 5, the lens array 190 is spaced apart from the light emitting element 101 and provided on the side of the first electrode 120 of the light emitting element 101. The wiring substrate 2 may have a support member (not shown) to support the lens array 190. The material of the lens array 190 is glass, for example.

The lens array 190 has the first lens 191, the second lens 192, the third lens 193 and the fourth lens 194. The lenses 191, 192, 193, 194 may have the same size and shape as each other. The lenses 191, 192, 193, 194 are, for example, condensing lenses or collimator lenses. The light generated in the active layer 106 becomes incident on the lenses 191, 192, 193, 194. The light exiting the lenses 191, 192, 193, 194 may be superimposed on each other (partly superimposed).

The first lens 191 is provided at a position overlapping with the first bouncing section 181, as viewed in a plan view, as shown in FIG. 2. The light bounced by the first bouncing section 181 (light having the traveling direction changed) becomes incident on the first lens 191.

The second lens 192 is provided at a position overlapping with the second bouncing section 182 and the second waveguide section 172, as viewed in a plan view. The light bounced by the second bouncing section 182 becomes incident on the second lens 192.

The third lens 193 is provided at a position overlapping with the third bouncing section 183 and the first waveguide section 170, as viewed in a plan view. The light bounced by the third bouncing section 182 becomes incident on the third lens 193.

The fourth lens 194 is provided at a position overlapping with the fourth bouncing section 184, as viewed in a plan view. The light bounced by the fourth bouncing section 184 becomes incident on the fourth lens 194.

The lenses 191, 192, 193, 194 are arranged in a staggered form (zigzag form) in the order of the first lens 191, the third lens 193, the second lens 192, and the fourth lens 194 in the direction from the first lateral surface 105 toward the second lateral surface 107. Thus, the lenses 191, 192, 193, 194 can be arranged with a high density and can illuminate an object with high uniformity, for example, compared with the case where lenses are provided in a matrix form. The distance between the neighboring lenses (for example, the distance between the center of the first lens 191 and the center of the third lens 193 as viewed in a plan view) is approximately 1.5 mm, for example. The lenses 191, 192, 193, 194 are provided in a plural number corresponding to the bouncing sections 181, 182, 183, 184, as shown in FIG. 1.

While the AlGaInP-based light emitting element 101 is described above, the light emitting element according to the invention can use any material that enables formation of an optical waveguide. As such a material, for example, semiconductor materials such as AlGaN-based, GaN-based, InGaN-based, GaAs-based, AlGaAs-based, InGaAs-based, InGaAsP-based, InP-based, GaP-based, AlGaP-based, or ZnCdSe-based can be used.

In the above, the light emitting element 101 is described as a so-called index-guiding type in which a difference in refractive index is provided between the area where the insulation layer 114 is formed and the area where the insulation layer 114 is not formed, that is, the area where the pillar-shaped section 112 is formed, so as to confine light. However, the light emitting element according to the invention may be a so-called gain-guiding type in which optical waveguides 160, 162 generated by injection current function as waveguide areas without providing a difference in refractive index by forming a pillar-shaped section, though not shown.

The light emitting device 100 can be applied, for example, to the light source of a projector, display, illumination device, measurement device or the like.

The light emitting device 100 has the following features, for example.

In the light emitting device 100, the first optical waveguide 160 has bouncing sections 181, 182 that change the traveling direction of the light guided by the first optical waveguide 160, and the second optical waveguide 162 has the bouncing sections 183, 184 that change the traveling direction of the light guided by the second optical waveguide 162. As viewed in a plane view, the first lens 191 is provided at a position overlapping with the first bouncing section 181. The second lens 192 is provided at a position overlapping with the second bouncing section 182 and the second optical waveguide 162. The third lens 193 is provided at a position overlapping with the third bouncing section 183 and the first optical waveguide 160. The fourth lens 194 is provided at a position overlapping with the fourth bouncing section 184. In this way, in the light emitting device 100, three lenses can be arranged to overlap with one optical waveguide, as viewed in a plan view. Specifically, the first optical waveguide 160 overlaps with the lenses 191, 192, 193. The second optical waveguide 162 overlaps with the lenses 192, 193, 194. Therefore, in the light emitting device 100, the distance between the lenses 191, 192, 193, 194 can be decreased without reducing the length of the optical waveguides 160, 162, compared with the case where lenses overlap only with both ends of the optical waveguide.

In the light emitting device 100, the bouncing sections 181, 182, 183, 184 change the traveling direction of light by diffraction. Therefore, in the light emitting device 100, manufacturing cost can be reduced, for example, compared with the case where the traveling direction of light is changed using a prism. Moreover, in the light emitting device 100, the distance between the optical waveguides 160, 162 can be reduced and miniaturization of the device can be realized compared with the case where the traveling direction of light is changed using a prism.

### 1.2. Method for Manufacturing Light Emitting Device

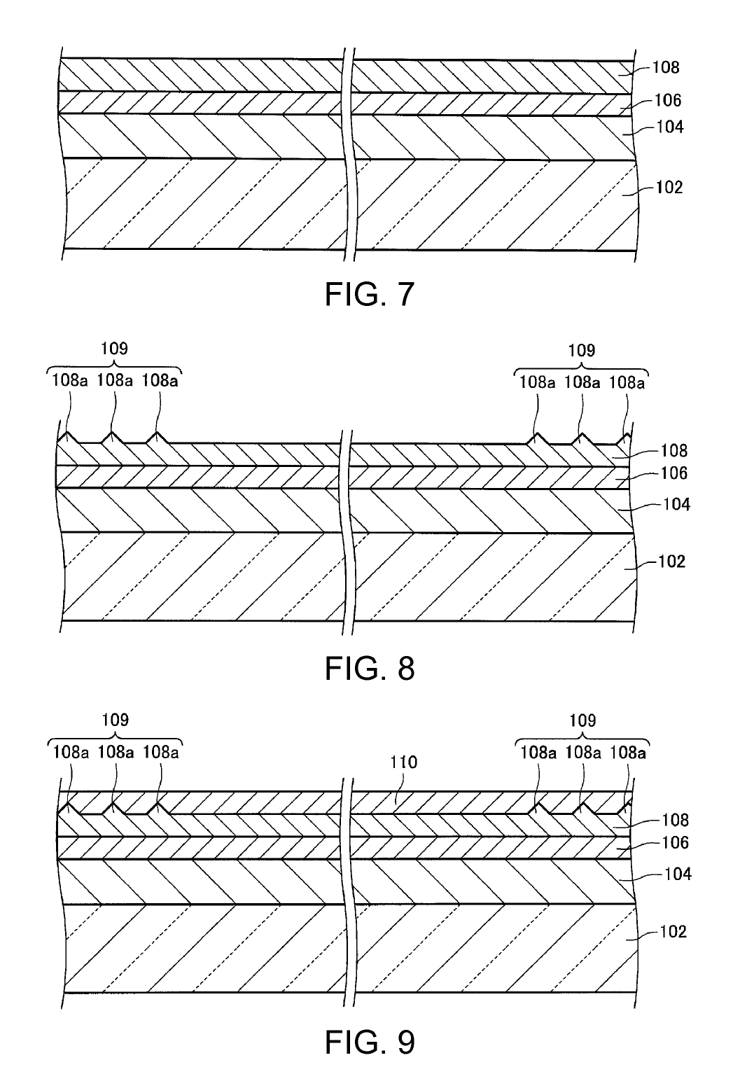

Next, a method for manufacturing the light emitting device according to the first embodiment will be described with reference to the drawings. FIGS. 7 to 9 are cross-sectional views schematically showing the manufacturing process of the light emitting device 100 according to the first embodiment, and corresponding to FIG. 3.

As shown in FIG. 7, the first cladding layer 104, the active layer 106, and the second cladding layer 108 are formed on the substrate 102 in this order by epitaxial growth. As a method for epitaxial growth, for example, the MOCVD (metal organic chemical vapor deposition) method or MBE (molecular beam epitaxy) method may be employed.

As shown in FIG. 8, the second cladding layer 108 is patterned to form plural protrusions 108a. The patterning is carried out, for example, by photolithography and etching. This process can form the grating section 109.

As shown in FIG. 9, the contact layer 110 is formed on the second cladding layer 108 by epitaxial growth. As a method for epitaxial growth, for example, the MOCVD method or MBE method may be employed.

As shown in FIG. 4, the contact layer 110 and the second cladding layer 108 are patterned. The patterning is carried out, for example, by photolithography and etching. This process can form the pillar-shaped section 112.

Next, the insulation layer 114 is formed to cover the lateral surface of the pillar-shaped section 112. Specifically, first, an insulation member (not shown) is deposited above the second cladding layer 108 (including the surface on the contact layer 110), for example, by the CVD (chemical vapor deposition) method, coating method or the like. Next, the upper surface of the contact layer 110 is exposed, for example, by etching. This process can form the insulation layer 114.

As shown in FIGS. 3 and 4, the second electrode 122 is formed on the contact layer 110. Next, the first electrode 120 is formed below the lower surface of the substrate 102. The electrodes 120, 122 are formed, for example, by the vacuum evaporation method. The order of forming the electrodes 120, 122 not particularly limited. This process can form the light emitting element 101.

As shown in FIG. 5, the light emitting element 101 is mounted on the wiring substrate 2 in a junction-down manner. Next, the lens array 190 is arranged in such a way that each of the bouncing sections 181, 182, 183, 184 of the light emitting element 101 overlaps with each of the corresponding lenses 191, 192, 193, 194.

This process can produce the light emitting device 100.

### 1.3. Modifications of Light Emitting Device

### 1.3.1. First Modification

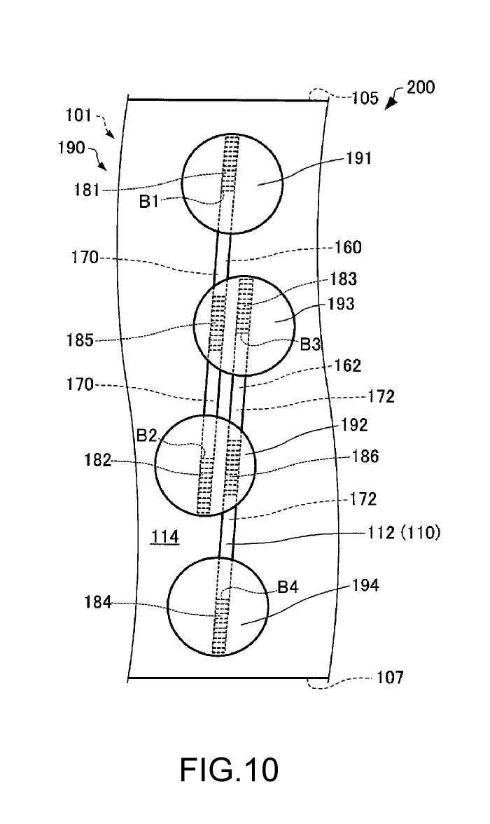

Next, a light emitting device according to a first modification of the first embodiment will be described with reference to the drawings. FIG. 10 is a plan view schematically showing a light emitting device 200 according to the first modification of the first embodiment, and corresponding to FIG. 2.

Hereinafter, member of the light emitting device 200 according to the first modification of the first embodiment that have similar functions to component members of the light emitting device 100 are denoted by the same reference numerals and will not be described further in detail.

In the light emitting device 100, the first optical waveguide 160 has the bouncing sections 181, 182, and the second optical waveguide 162 has the bouncing sections 183, 184, as shown in FIG. 2. Meanwhile, in the light emitting device 200, the first optical waveguide 160 also has a fifth bouncing section 185, and the second optical waveguide 162 also has a sixth bouncing section 186, as shown in FIG. 10.

The fifth bouncing section 185 is provided at a position overlapping with the third lens 193, as viewed in a plan view. The fifth bouncing section 185 may have the same shape and the same function as the bouncing sections 181, 182. The fifth bouncing section 185 is provided at a part of the first waveguide section 170. The first waveguide section 170 extends from the first bouncing section 181 to the fifth bouncing section 185 and further extends from the fifth bouncing section 185 to the second bouncing section 182. Unlike the bouncing sections 181, 182, the fifth bouncing section 185 bounces only a part of the light and therefore an adjustment can be made thereto, for example, reducing the number of the protrusions 108a or the like.

The fifth bouncing section 185 changes the traveling direction of a part of the light guided by the first optical waveguide 160. Specifically, a part of the light guided by the first optical waveguide 160 is bounced by the fifth bouncing section 185 and becomes incident on the third lens 193.

The sixth bouncing section 186 is provided at a position overlapping with the second lens 192, as viewed in a plan view. The sixth bouncing section 186 may have the same shape and the same function as the bouncing sections 183, 184. Unlike the bouncing sections 183, 184, the sixth bouncing section 186 bounces only a part of the light and therefore an adjustment can be made thereto, for example, reducing the number of the protrusions 108a or the like. The sixth bouncing section 186 is provided at a part of the second waveguide section 172. The second waveguide section 172 extends from the third bouncing section 183 to the sixth bouncing section 186 and further extends from the sixth bouncing section 186 to the fourth bouncing section 184.

The sixth bouncing section 186 changes the traveling direction of a part of the light guided by the second optical waveguide 162. Specifically, a part of the light guided by the second optical waveguide 162 is bounced by the sixth bouncing section 186 and becomes incident on the second lens 192.

In the light emitting device 200, the number of light emitting sections in the light emitting element 101 can be increased, compared with the light emitting device 100.

### 1.3.2. Second Modification

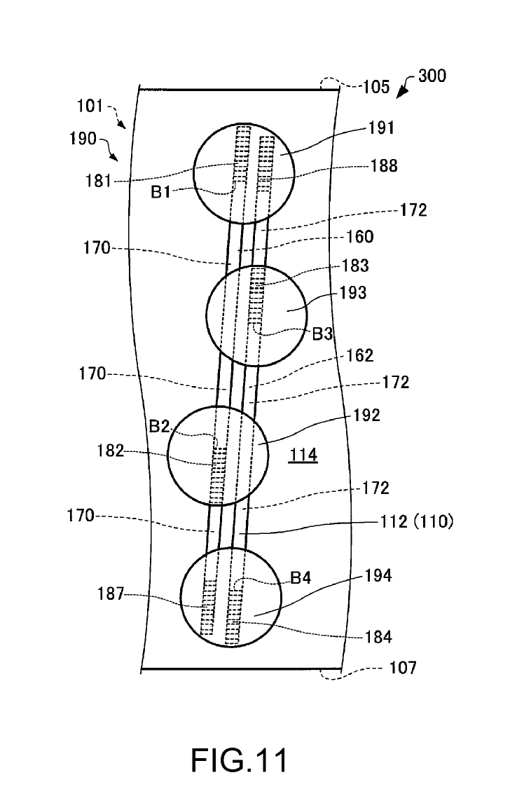

Next, a light emitting device according to a second modification of the first embodiment will be described with reference to the drawings. FIG. 11 is a plan view schematically showing a light emitting device 300 according to the second modification of the first embodiment, and corresponding to FIG. 2.

Hereinafter, members of the light emitting device 300 according to the second modification of the first embodiment that have similar functions to component members of the light emitting device 100 are denoted by the same reference numerals and will not be described further in detail.

In the light emitting device 100, the first optical waveguide 160 has the bouncing sections 181, 182, and the second optical waveguide 162 has the bouncing sections 183, 184, as shown in FIG. 2. Meanwhile, in the light emitting device 300, the first optical waveguide 160 also has a seventh bouncing section 187, and the second optical waveguide 162 also has a eighth bouncing section 188, as shown in FIG. 11.

The seventh bouncing section 187 is provided at a position overlapping with the fourth lens 194, as viewed in a plan view. The seventh bouncing section 187 may have the same shape and the same function as the bouncing sections 181, 182. Unlike the bouncing sections 181, 182, the seventh bouncing section 187 bounces only a part of the light and therefore an adjustment can be made thereto, for example, reducing the number of the protrusions 108a or the like. The first waveguide section 170 extends from the first bouncing section 181 to the second bouncing section 182 and further extends from the second bouncing section 182 to the seventh bouncing section 187.

The seventh bouncing section 187 changes the traveling direction of the light guided by the first optical waveguide 160. Specifically, the light guided by the first optical waveguide 160 is bounced by the seventh bouncing section 187 and becomes incident on the fourth lens 194.

The eighth bouncing section 188 is provided at a position overlapping with the first lens 191, as viewed in a plan view. The eighth bouncing section 188 may have the same shape and the same function as the bouncing sections 183, 184. Unlike the bouncing sections 183, 184, the eighth bouncing section 188 bounces only a part of the light and therefore an adjustment can be made thereto, for example, reducing the number of the protrusions 108a or the like. The second waveguide section 172 extends from the eighth bouncing section 188 to the third bouncing section 183 and further extends from the third bouncing section 183 to the fourth bouncing section 184.

The eighth bouncing section 188 changes the traveling direction of the light guided by the second optical waveguide 162. Specifically, the light guided by the second optical waveguide 162 is bounced by the eighth bouncing section 188 and becomes incident on the first lens 191.

In the light emitting device 300, the length of the optical waveguides 160, 162 can be increased, compared with the light emitting device 100. Therefore, in the light emitting device 300, light output can be increased. In the light emitting device 300, the length of the optical waveguides 160, 162 is approximately 4.5 mm, for example.

### 1.3.3. Third Modification

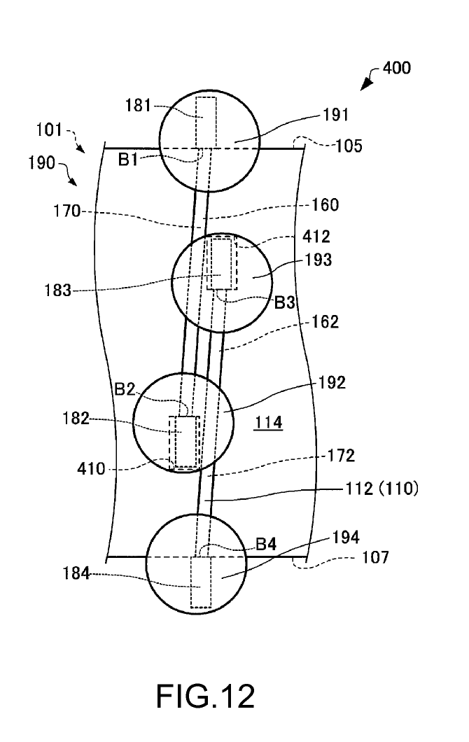

Next, a light emitting device according to a third modification of the first embodiment will be described with reference to the drawings. FIG. 12 is a plan view schematically showing a light emitting device 400 according to the third modification of the first embodiment, and corresponding to FIG. 2.

Hereinafter, members of the light emitting device 400 according to the third modification of the first embodiment that have similar functions to component members of the light emitting device 100 are denoted by the same reference numerals and will not be described further in detail.

In the light emitting device 100, the bouncing sections 181, 182, 183, 184 function as diffraction gratings and change the traveling direction of the light guided by the optical waveguides 160, 162, as shown in FIG. 2. Meanwhile, in the light emitting device 400, the bouncing sections 181, 182, 183, 184 are prisms that change the traveling direction of the light guided by the optical waveguides 160, 162, as shown in FIG. 12. The shape of the bouncing sections 181, 182, 183, 184 is not particularly limited as long the bouncing sections can cause the light guided by the optical waveguides 160, 162 to become incident on the lenses 191, 192, 193, 194.

In the light emitting element 101 of the light emitting device 400, a first opening 410 and a second opening 412 are formed. The openings 410, 412 are, for example, closed-bottom holes penetrating the light emitting element from the second electrode 122 to the first cladding layer 104. In the illustrated example, the openings 410, 412 have a rectangular shape, as viewed in a plan view. The openings 410, 412 may be formed by patterning based on photolithography and etching.

In the light emitting device 400, the first waveguide section 170 of the first optical waveguide 160 extends from the first lateral surface 105 to the first opening 410. In the illustrated example, the first bouncing section 181 is provided in contact with the first lateral surface 105. The second bouncing section 182 is provided in contact with the inner surface of the first opening 410.

In the light emitting device 400, the second waveguide section 172 of the second optical waveguide 162 extends from the second opening 412 to the second lateral surface 107. In the illustrated example, the third bouncing section 183 is provided in contact with the inner surface of the second opening 412. The fourth bouncing section 184 is provided in contact with the second lateral surface 107.

In the light emitting device 400, as in the light emitting device 100, the distance between the lenses 191, 192, 193, 194 can be decreased without reducing the length of the optical waveguides 160, 162.

### 2. Second Embodiment

### 2.1. Light Emitting Device

Next, a light emitting device according to a second embodiment will be described with reference to the drawings.

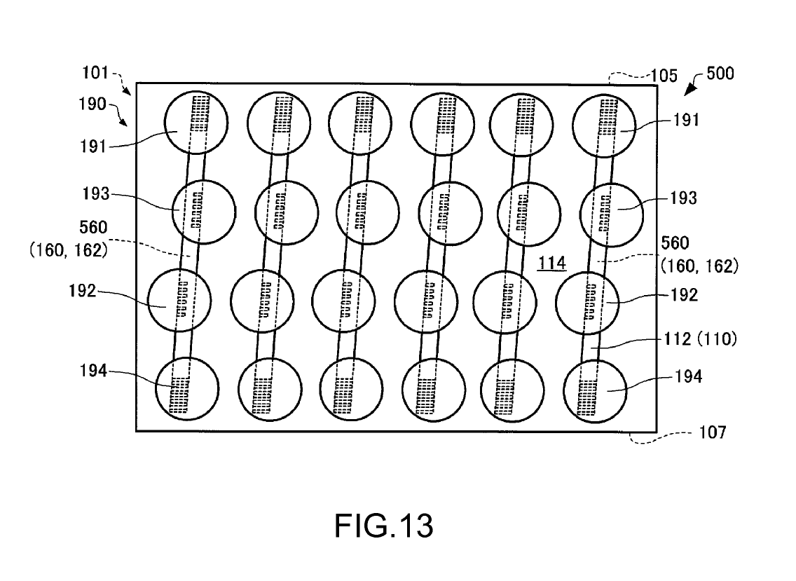

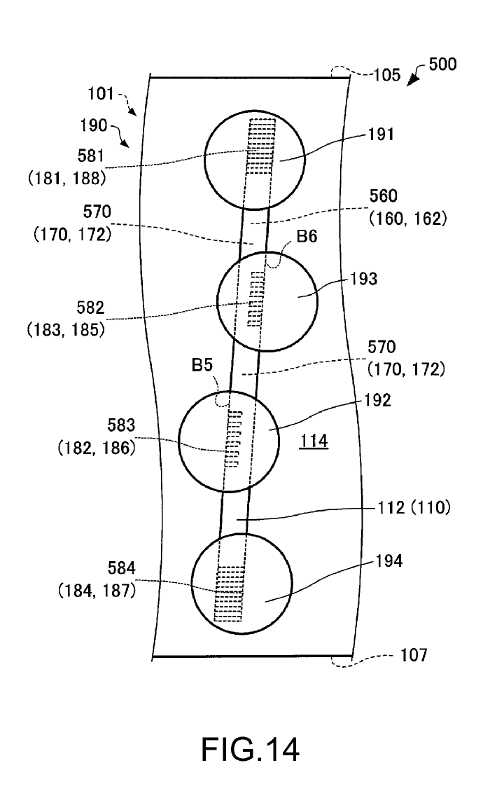

FIGS. 13 and 14 are plan views schematically showing a light emitting device 500 according to the second embodiment. In FIGS. 13 and 14, the second electrode 122 is omitted and a part of the lens array 190 is shown perspectively. FIG. 14 is an enlarged view of a part of the light emitting device 500 shown in FIG. 13.

Hereinafter, member of the light emitting device 500 according to the second embodiment that have similar functions to component members of the light emitting devices 100, 200, 300 are denoted by the same reference numerals and will not be described further in detail.

In the light emitting device 100, the first optical waveguide 160 and the second optical waveguide 162 are spaced apart from each other, as shown in FIGS. 1 and 2. Meanwhile, in the light emitting device 500, the first optical waveguide 160 and the second optical waveguide 162 are integrally formed, as shown in FIGS. 13 and 14. It can also be said that the optical waveguides 160, 162 contact each other and form a single optical waveguide. The optical waveguides 160, 162 are integrally formed, thus forming an integrated optical waveguide 560.

In the light emitting device 500, the first optical waveguide 160 has the bouncing sections 181, 182, 185, 187, as shown in FIG. 14. The first waveguide section 170 extends from the first bouncing section 181 to the fifth bouncing section 185, then extends from the fifth bouncing section 185 to the second bouncing section 182, and further extends from the second bouncing section 182 to the seventh bouncing section 187.

In the light emitting device 500, the second optical waveguide 162 has the bouncing sections 183, 184, 186, 188. The second waveguide section 172 extends from the eighth bouncing section 188 to the third bouncing section 183, then extends from the third bouncing section 183 to the sixth bouncing section 186, and further extends from the sixth bouncing section 186 to the fourth bouncing section 184.

The first waveguide section 170 and the second waveguide section 172 are integrally formed, thus forming an integrated waveguide section 570. The first bouncing section 181 and the eighth bouncing section 188 are integrally formed, thus forming a first integrated bouncing section 581. The third bouncing section 183 and the fifth bouncing section 185 are integrally formed, thus forming a second integrated bouncing section 582. The second bouncing section 182 and the sixth bouncing section 186 are integrally formed, thus forming a third integrated bouncing section 583. The fourth bouncing section 184 and the seventh bouncing section 187 are integrally formed, thus forming a fourth integrated bouncing section 584.

The second integrated bouncing section 582 has a smaller width than the width of the integrated waveguide section 570 (the size in the direction orthogonal to the extending direction of the waveguide sections 170, 172). The third integrated bouncing section 583 has a smaller width than the integrated waveguide section 570. In the illustrated example, the second integrated bouncing section 582 is provided in contact with a boundary (boundary along the longitudinal direction) B5 on one side of the integrated waveguide section 570, and the third integrated bouncing section 583 is provided in contact with a boundary (boundary along the longitudinal direction) B6 on the other side of the integrated waveguide section 570. Thus, direct multiple reflection between the second integrated bouncing section 582 and the third integrated bouncing section 583, of the light generated in the integrated optical waveguide 560, can be suppressed. Therefore, formation of a direct resonator can be avoided and laser oscillation of the light generated in the integrated optical waveguide 560 can be suppressed. Although not shown, the width of the integrated bouncing sections 582, 583 may be the same as the width of the integrated optical waveguide 560.

In the light emitting device 500, as in the light emitting device 100, the distance between the lenses 191, 192, 193, 194 can be decreased without reducing the length of the optical waveguides 160, 162.

### 2.2. Method for Manufacturing Light Emitting Device

The method for manufacturing the light emitting device 500 according to the second embodiment is basically the same as the method for manufacturing the light emitting device 100 according to the first embodiment and therefore will not be described further in detail.

### 2.3. Modification of Light Emitting Device

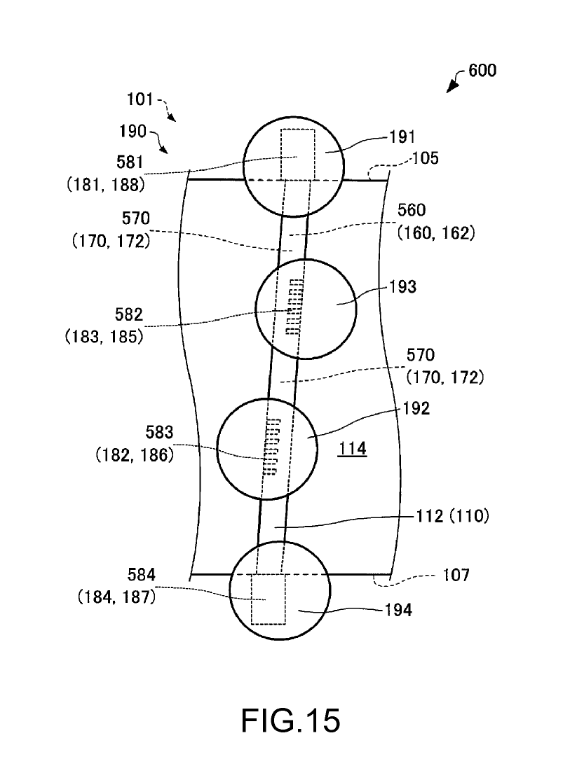

Next, a light emitting device according to a modification of the second embodiment will be described with reference to the drawings. FIG. 15 is a plan view schematically showing a light emitting device 600 according to the modification of the second embodiment, and corresponding to FIG. 14.

Hereinafter, member of the light emitting device 600 according to the modification of the second embodiment that have similar functions to component members of the light emitting devices 400, 500 are denoted by the same reference numerals and will not be described further in detail.

In the light emitting device 500, the integrated bouncing sections 581, 584 function as diffraction gratings and change the traveling direction of the light guided by the integrated optical waveguide 560, as shown in FIG. 14. Meanwhile, in the light emitting device 600, the integrated bouncing sections 581, 584 are prisms that change the traveling direction of the light guided by the integrated optical waveguide 560, as shown in FIG. 15. In the illustrated example, the first integrated bouncing section 581 is provided in contact with the first lateral surface 105. The fourth integrated bouncing section 584 is provided in contact with the second lateral surface 107.

In the light emitting device 600, as in the light emitting device 500, the distance between the lenses 191, 192, 193, 194 can be decreased without reducing the length of the optical waveguides 160, 162.

### 3. Third Embodiment

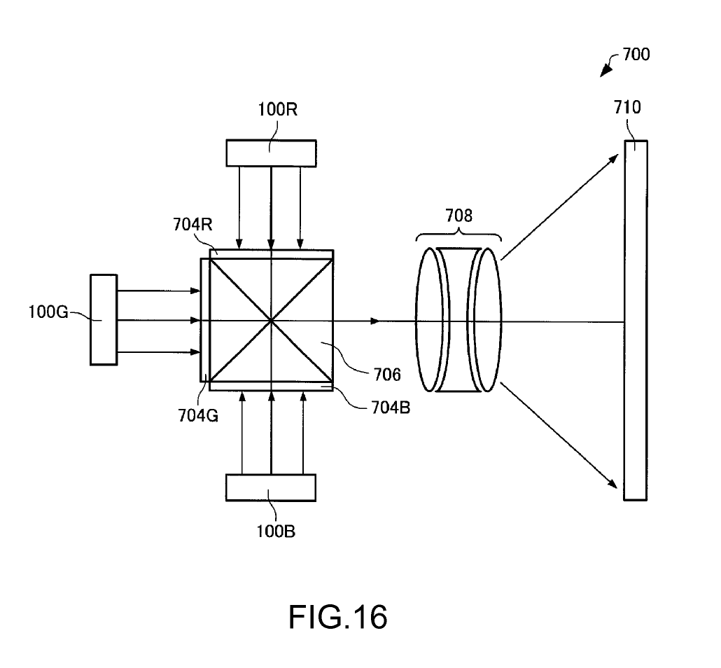

Next, a projector according to a third embodiment will be described with reference to the drawings. FIG. 16 schematically shows a projector 700 according to the third embodiment. In FIG. 16, for convenience, a casing that forms the projector 700 is omitted and the light emitting device 100 is simplified.

The projector 700 includes a red light source 100R, a green light source 100G, and a blue light source 100B that emit red light, green light, and blue light, respectively, as shown in FIG. 16. The red light source 100R, the green light source 100G and the blue light source 100B are light emitting devices according to the invention. Hereinafter, an example using the light emitting device 100 as a light emitting device according to the invention will be described.

The projector 700 includes the light emitting devices 100 (light sources 100R, 100G, 100B), transmission-type liquid crystal light valves (light modulation devices) 704R, 704G, 704B, and a projection lens (projection device) 708.

The light emitted from the light sources 100R, 100G, 100B becomes incident on the respective liquid crystal light valves 704R, 704G, 704B. Each of the respective liquid crystal light valves 704R, 704G, 704B modulates the incident light according to image information. The projection lens 708 magnifies and projects images formed by the liquid crystal light valves 704R, 704G, 704B on a screen (display surface) 710.

The projector 700 also include a cross dichroic prism (color combining unit) 706 that combines the light emitted from the liquid crystal light valves 704R, 704G, 704B and guides the combined light to the projection lens 708.

The three color light beams modulated by the respective liquid crystal light valves 704R, 704G, 704B become incident on the cross dichroic prism 706. The cross dichroic prism. 706 is formed by four right-angled prisms bonded together, and a dielectric multilayer film that reflects red light and a dielectric multilayer film that reflects blue light are arranged on the inner surfaces of the prisms in a cruciform. The three color beams are combined by these dielectric multilayer films, thus forming light that represents a color image. The combined light is projected on the screen 710 by the projection lens 708 composing a projection optical system. Thus, an enlarged image is displayed.

The projector 700 can include the light emitting device 100 in which the distance between the lenses 191, 192, 193, 194 can be decreased without reducing the length of the optical waveguides 160, 162.

The projector 700 employs an optical system in which the light emitting device 100 is arranged directly below the liquid crystal light valve 704 so that condensing of light and uniform illumination are simultaneously carried out using the lens array 190 of the light emitting device 100 (backlight system). Therefore, in the projector 700, reduction in loss and reduction in the number of components in the optical system can be achieved.

In the above example, the transmission-type liquid crystal light valves are used as light modulation devices. However, other types of light valves than liquid crystal or reflection-type light valves may be used. Such light valves may be, for example, reflection-type liquid crystal light valves or digital micromirror devices. The configuration of the projection optical system may be changed properly according to the type of the light valves to be used.

The light emitting device 100 can also be applied to the light source of a scanning-type image display device (projector) in which the light from the light emitting device 100 is swept to display an image with a desired size on a screen.

The embodiments and modifications are non-limiting examples. For example, each of the embodiments and modifications can be suitably combined.

The invention includes substantially the same configurations as the configurations described in the embodiments (for example, a configuration with the same function, method and result, or a configuration with the same objective and effect). The invention also includes configurations in which a non-essential part of the configurations described in the embodiments is replaced. The invention also includes configurations that have the same advantageous effects as the configurations described in the embodiments, or configurations that can achieve the same objective. Moreover, the invention includes configurations in which a known technique is added to the configurations described in the embodiments.

The entire disclosure of Japanese Patent Application No. 2013-179094, filed Aug. 30, 2013 is expressly incorporated by reference herein.

What is claimed is:

1. A light emitting device comprising:
an active layer which is injected with current and generates light;
a first cladding layer and a second cladding layer which sandwich the active layer; and
a first lens, a second lens, a third lens, and a fourth lens on which the light generated by the active layer becomes incident,
the active layer forming a first optical waveguide and a second optical waveguide which guide light,
the first optical waveguide having a first bouncing section and a second bouncing section which change a traveling direction of the light guided by the first optical waveguide,
the second optical waveguide has a third bouncing section and a fourth bouncing section which change a traveling direction of the light guided by the second optical waveguide,
the first lens being provided at a position overlapping with the first bouncing section, as viewed from a stacking direction of the active layer and the first cladding layer,
the second lens being provided at a position overlapping with the second bouncing section and the second optical waveguide, as viewed from the stacking direction,
the third lens being provided at a position overlapping with the third bouncing section and the first optical waveguide, as viewed from the stacking direction, and
the fourth lens being provided at a position overlapping with the fourth bouncing section, as viewed from the stacking direction.

2. The light emitting device according to claim 1, wherein the first bouncing section, the second bouncing section, the third bouncing section and the fourth bouncing section change the traveling direction of light by diffraction.

3. The light emitting device according to claim 1, wherein the first optical waveguide has a fifth bouncing section provided at a position overlapping with the third lens, as viewed from the stacking direction.

4. The light emitting device according to claim 1, wherein the second optical waveguide has a sixth bouncing section provided at a position overlapping with the second lens, as viewed from the stacking direction.

5. The light emitting device according to claim 1, wherein the first optical waveguide has a seventh bouncing section provided at a position overlapping with the fourth lens, as viewed from the stacking direction.

6. The light emitting device according to claim 1, wherein the second optical waveguide has an eighth bouncing section provided at a position overlapping with the first lens, as viewed from the stacking direction.

7. The light emitting device according to claim 1, wherein the first optical waveguide and the second optical waveguide are integrally formed.

8. A projector comprising:
the light emitting device according to claim 1;
a light modulation device which modulates light emitted from the light emitting device, according to image information; and
a projection device which projects an image formed by the light modulation device.

9. A projector comprising:
the light emitting device according to claim 2;
a light modulation device which modulates light emitted from the light emitting device, according to image information; and
a projection device which projects an image formed by the light modulation device.

10. A projector comprising:
the light emitting device according to claim 3;
a light modulation device which modulates light emitted from the light emitting device, according to image information; and
a projection device which projects an image formed by the light modulation device.

11. A projector comprising:
the light emitting device according to claim 4;
a light modulation device which modulates light emitted from the light emitting device, according to image information; and
a projection device which projects an image formed by the light modulation device.

12. A projector comprising:
the light emitting device according to claim 5;
a light modulation device which modulates light emitted from the light emitting device, according to image information; and
a projection device which projects an image formed by the light modulation device.

13. A projector comprising:
the light emitting device according to claim 6;
a light modulation device which modulates light emitted from the light emitting device, according to image information; and
a projection device which projects an image formed by the light modulation device.

14. A projector comprising:
the light emitting device according to claim 7;
a light modulation device which modulates light emitted from the light emitting device, according to image information; and
a projection device which projects an image formed by the light modulation device.
